(19) United States
(12) Patent Application Publication
(10) Pub. No.: US 2026/0110537 A1
(43) Pub. Date: Apr. 23, 2026

(54) MECHANICALLY AMPLIFIED HIGH-PRECISION, HIGH-STABILITY ANGULAR RATE SENSORS

(71) Applicant: Shanghai Roadix Technology Co., Ltd, Shanghai (CN)

(72) Inventor: Daniel Lapadatu, Bucharest (RO)

(21) Appl. No.: 19/153,972

(22) PCT Filed: Feb. 12, 2024
(86) PCT No.: PCT/EP2024/053452

§ 371 Date: Aug. 6, 2025

(30) Foreign Application Priority Data
Feb. 13, 2023 (GB) 2302004.3

(51) Int. Cl. G01C 19/5621; G01C 19/5747; G01C 19/5769

(52) U.S. Cl. CPC G01C 19/5621; G01C 19/5747; G01C 19/5769

(57) ABSTRACT

Architectures and methods of structuring high-precision, high-stability MEMS-based angular rate sensors are provided. The structures include implements that allow the suppression of in-phase movement of the coupled masses, the mechanical enhancement of the drive movement in the driving blocks and the mechanical enhancement of the Coriolis-induced movement in the sensing blocks. Compared to the prior art, the presented architectures minimise the mechanical momenta generated by the actuation forces with the drive, sense and Q-compensation blocks. Furthermore, methods include several implements for the purpose of achieving stress-decoupling between the MEMS device and the environment and the reduction of the anchor damping.

### TECHNICAL FIELD

Aspects of the present invention generally relate to design and fabrication methods of angular rate sensors (ARS). More specifically, aspects of the present invention are directed to micro-electromechanical systems (MEMS) vibratory gyroscopes for tactical and navigation grade applications.

### BACKGROUND

US 2010/0313657A1 and U.S. Pat. No. 11,118,907B2 disclose examples of prior art devices, which are very large in size and thus present a challenge for fabrication and effective functionality. Masses and other device elements that should be rigid are becoming flexible in the out of plane direction, thus compromising the functionality of the devices. Another disadvantage of such prior art devices is that the drive and sense modes are not entirely decoupled. Furthermore, these devices are prone to quadrature errors caused by residual orthogonal drive motion inherent to the illustrated mechanical couplings between the various masses and levers. For example, U.S. Pat. No. 11,118,907B2 shows a U-shaped decoupling flexure that is not eliminating the residual orthogonal movement, thus contributing to quadrature errors.

US 2014 0260615A1 describes a lever having four rigid beams, initially parallel, connected by flexible joints. The lever suppresses the in-phase movements of the vibrating elements.

WO2022248647A1 describes a dual-mass device that partially addresses the above-mentioned issues. However, in the disclosed arrangement, the mechanical momenta associated with the actuation forces within the drive and quadrature compensation blocks become a secondary source of uncompensated quadrature errors. As such, the drive actuation and detection blocks are not properly aligned.

Aspects of the present invention address problems with the prior art.

### SUMMARY OF THE INVENTION

The invention is defined in the set of appended claims. Further aspects/embodiments/examples not included in the invention are also described.

Aspects of the present invention relate to dual- and quad-mass tuning fork angular rate sensors that address the limitations of and improve upon the existing prior art.

The device measures angular rate about a Z-axis. The device comprises a substrate defining a “reference surface” or “reference plane”. The Z-axis is defined as an axis perpendicular to the reference plane. Conveniently, the reference plane is the plane of the wafer in which the MEMS structures (masses, beams, frames, anchors etc.) are manufactured.

According to an independent aspect, there is provided a dual-mass micro-electromechanical system (MEMS) device for measuring Z-axis angular rate according to claim 1.

Advantageously, the pair of mechanical amplifiers may be configured to provide a linearly coupled, amplified anti-phase drive mode motion and balanced to minimize the energy dissipation to the substrate, resulting in increased drive mode quality factor, improved stability of the drive mode motion and improved angle random walk of the device.

Advantageously, the further mechanical amplifier may be configured to provide a linearly coupled, amplified anti-phase sense-mode motion and balanced to minimize the energy dissipation to the substrate, resulting in increased sense-mode quality factor, increased rate sensitivity, increased signal-to-noise ratio and improved angle random walk of the device.

According to a dependent aspect of the invention, there is provided a quadruple-mass micro-electro-mechanical system (MEMS) device for measuring Z-axis angular rate, the device being realised by mechanically connecting two dual-mass devices defined above, to achieve, advantageously, better performance, improved stability and improved rejection of vibrations and linear accelerations (reduced ARW).

It will be appreciated that the mass of the shuttles is minimised, but without affecting their mechanical rigidity.

Suppression of the in-phase movement of the proof masses means that the anti-phase movement is left as the fundamental resonance mode of the system, which considerably improves the bias stability and ARW. In this configuration, the drive mode, corresponding to the anti-phase movement of the proof masses, is the fundamental mode. The drive structure function is to excite and maintain the drive mode oscillation at a pre-defined, stable amplitude.

Since the stability of the drive mode amplitude is directly linked the stability of the ARS, measuring accurately this amplitude is quintessential for high-precision, high-stability devices. For the devices with frames according to the first aspect of the invention, the structure that provides the mechanical amplification of the drive mode motion allows for a better signal-to-noise ratio within the blocks that control the drive mode amplitude. Conveniently, the same mechanical amplifier also suppresses the in-phase movement of the frames and, consequently, of the proof masses.

The “Coriolis-induced movement” refers to the vibratory movement of the proof of mass generated by the Coriolis force; it is perpendicular to both the drive movement and the angular rate vector, thus occurring in the Y-direction. The “sense movement” refers to the Coriolis-induced movement of the proof masses and the movement of the sense shuttles, conveniently amplified and converted back in the X-direction.

Advantageously, the devices comprise mechanical structures that amplify the Coriolis-induced Y-movement of the proof masses into X-movement of the sense shuttles. An amplifying mechanical structure has a number of advantages:
i. it suppresses the parasitic in-phase movement of the proof masses and the sense shuttles, thus highly rejecting all common-mode signals originating from the environment, such as shocks and vibrations;
ii. it amplifies the mechanical Coriolis movement, thus improving several key performance parameters of the device, such as sensitivity and ARW;
iii. it reduces the sense actuation force needed to counter-balance the Coriolis force, thus providing a particular advantage for the closed loop operating devices; and
iv. it converts the Coriolis-induced Y-movement into X-sense movement, which prior art elements including known levers, for example, do not achieve.

Point iv) is a particular benefit over the prior art devices, because the mechanical structure provides better mechanical decoupling between sense motion and drive motion, better rejection of vibrations and better linewidth control in the DRIE process and, consequently better geometry control during the fabrication.

Advantageously, in the absence of an Z-axis angular rate, the drive and sense modes are decoupled from each other so that while one mode is excited the other is not affected.

The drive shuttles are mechanically restricted to move in the drive mode direction (X). In a dependent aspect, the first pair of vibratory structures are mechanically connected by means of at least one in-phase movement supressing element. The suppressing element may additionally comprise other elements such a springs to allow rotations about the Z-axis. An advantage of including the at least one suppressing element is that the in-phase movement of the proof masses is suppressed, meaning that this mode is forcefully moved to considerably higher frequencies. In contrast, in known devices (e.g. such as Sensonor SAR10, SAR100, SAR500 devices), it is the in-phase movement that is normally the fundamental mode and, consequently, is unwillingly excited and acting as a parasitic oscillation, degrading their performance.

Preferably, the drive and sense modes are parallel to the reference plane.

The device represents a tune-fork vibratory gyroscope with decoupled drive and sense modes, in combination with in-plane linear movement for both the drive and sense modes. “In-plane” movement refers to movement occurring within or parallel to the reference plane. This is in contrast to “out-of-plane” movement which occurs outside the reference plane. In-plane linear drive and sense movement provides a number of advantages over out-of-plane alternatives. In particular, the in-plane linear drive and sense movement of the angular rate sensor allows large amplitudes of movement, advantageously achieving a much higher sensitivity to Coriolis forces compared to out-of-plane alternatives. Furthermore, all devices using out-of-plane movement inherently suffer of out-of-plane unbalanced momenta acting upon the mechanical structures.

Further dependent aspects are provided in the set of claims.

By mechanically connecting two such devices, an improved quadruple-mass angular rate sensor device can be obtained. Such a device has, advantageously, better performance than its dual-mass equivalent, featuring improved stability and improved rejection of vibrations and linear accelerations.

### BRIEF DESCRIPTION OF THE DRAWINGS

Below, the present invention and additional examples are described in detail with reference to the attached figures, in which:

FIG. 1 shows a schematic of a dual-mass angular rate sensor including mechanical amplifiers for both the drive and the Coriolis motions.

FIG. 2 illustrates the mechanical amplifier of the drive motion.

FIG. 3 illustrates the mechanical amplifier of the Coriolis motion.

FIG. 4 illustrates the generic geometry of the employed mechanical amplifiers.

FIG. 5 shows a schematic of a dual-mass angular rate sensor featuring mechanical amplifiers for the Coriolis motion.

FIG. 6 shows a practical implementation of a dual-mass angular rate sensor including mechanical amplifiers for the Coriolis motion, according to aspects of the present invention.

FIG. 7 shows a schematic of a quad-mass angular rate sensor including mechanical amplifiers for both the drive and the Coriolis motions.

FIG. 8 shows an implementation of a quad-mass angular rate sensor featuring mechanical amplifiers for both the drive and the Coriolis motions.

FIG. 9 shows a schematic of a quad-mass angular rate sensor featuring mechanical amplifiers for the Coriolis motion.

FIG. 10 shows the schematic of the device from FIG. 7 pictured in the drive motion configuration.

FIG. 11 shows the schematic of the device from FIG. 7 pictured in the sense motion configuration.

FIG. 12 shows the FEM simulation of the drive motion for the device illustrated in FIG. 7.

FIG. 13 shows the FEM simulation of the sense motion for the device illustrated in FIG. 7.

FIG. 14 shows the schematic of the device from FIG. 5 pictured in the drive motion configuration.

FIG. 15 shows the schematic of the device from FIG. 5 pictured in the sense motion configuration.

FIG. 16 shows the FEM simulation of the drive motion for the device illustrated in FIG. 5.

FIG. 17 shows the FEM simulation of the sense motion for the device illustrated in FIG. 5.

FIG. 18 shows an embodiment of the mechanical amplifier of the Coriolis motion.

FIG. 19 shows a drive mode lever schematic.

FIG. 20 shows an example of the drive lever movable pivot.

FIG. 21 shows an example of the drive lever fixed pivot.

FIG. 22 shows an example of the anchor damping reduction structure.

FIG. 23 shows the electrical blocks within the dual-mass angular rate sensor including mechanical amplifiers for the Coriolis motion.

FIG. 24 shows the electrical blocks within the quad-mass angular rate sensor including mechanical amplifiers for both the drive and the Coriolis motions.

FIG. 25 shows a preferred embodiment of the comb drives used for the drive and sense mode actuation and detection.

FIG. 26 shows a preferred embodiment of the comb drives used for the quadrature compensation blocks.

FIG. 27 shows the preferred embodiment of the comb drives used for the frequency adjust blocks.

FIG. 28 shows the C-SOI wafer as the preferred starting material for fabricating the device.

FIG. 29 shows a generic cross-sectional view of the micro-machined C-SOI wafer.

FIG. 30 shows a generic cross-sectional view of the completely fabricated angular rate sensor.

### DETAILED DESCRIPTION

A first embodiment of the invention comprises a dual-mass architecture comprising mechanical amplifiers for both the drive mode motion and the Coriolis motion, thus addressing several limitations of conventional single-axis MEMS angular rate devices.

A second embodiment of the invention comprises a quadruple-mass (quad-mass) architecture including mechanical amplifiers for both the drive mode motion and the Coriolis motion. This is achieved by coupling two dual-mass devices according to the first embodiment, to achieve full symmetry thus providing full rejection of external vibrations, shocks and linear accelerations, as well as achieving higher quality factors.

A third embodiment of the invention comprises a dual-mass architecture, based on the preferred embodiment, comprising a mechanical amplifier only for the Coriolis motion, which is a compromise between size and performance.

A fourth embodiment of the invention comprises quadruple-mass architecture having mechanical amplifiers only for the Coriolis motion, This is achieved by coupling by coupling two dual-mass devices according to the third embodiment, to achieve full symmetry thus providing full rejection of external vibrations, shocks and linear accelerations, as well as achieving higher quality factors.

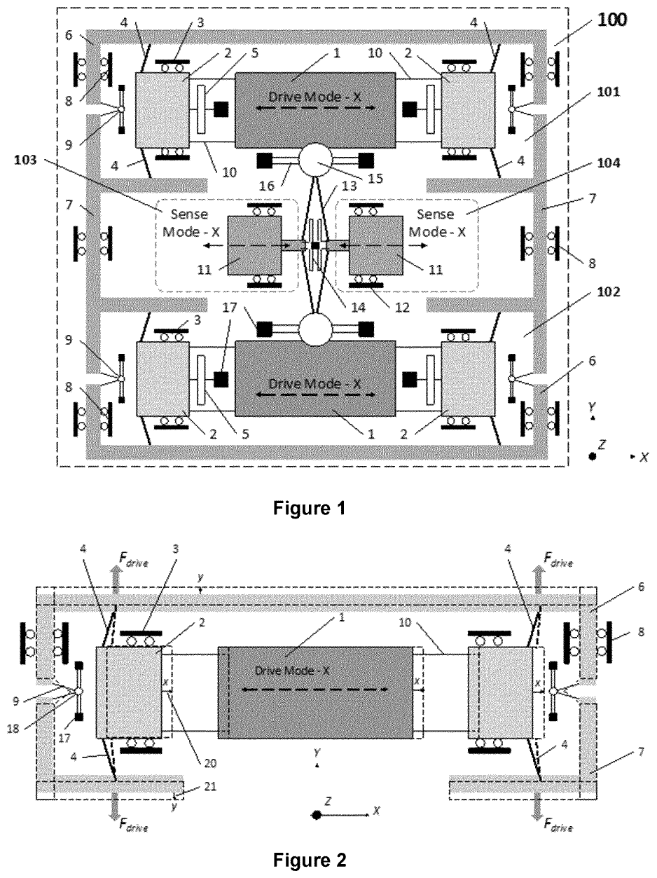

FIG. 1 illustrates the mechanical schematic of a first embodiment of the dual-mass MEMS device for measuring Z-axis angular rate (100), comprising mechanical amplifiers for both the drive motion (4) and the Coriolis motion (13), wherein the white circles represent movable pivots and the black rectangles represent anchors.

The device (100) comprises: a first pair of identical vibratory structures, the upper drive block 101 and the lower drive block 102, each block comprising a proof mass 1, each proof mass being mechanically coupled to a drive shuttle 2. The drive shuttles 2 generate by electrostatic actuation the drive mode motion of the proof masses 1 in drive mode direction (X). The first pair of vibratory structures are elastically connected by means of a frame coupler 9 to synchronizing “frames” 6 and 7, such that the drive mode corresponds to the anti-phase movement of said proof masses, while the in-phase movement of the proof masses 1, drive shuttles 2 and frames 6, 7 is suppressed. It will be appreciated that by a “frame” we mean any rigid element that can take any suitable shape. The frames 6, 7 are rigid and they do not rotate as a lever would function (in contrast to the embodiment described in FIG. 5). The frames 6, 7 are constrained to move only in the direction perpendicular to the drive mode. Thus their movement is only translational, in contrast with the rotational movement of a lever.

The device (100) further comprises a second pair of identical vibratory structures, the left-hand side sense block 103 and the right-hand side sense block 104, each including a sense shuttle 11. The first and second pairs of vibratory structures are elastically coupled to each other by means of a mechanical structure 13 that converts the Coriolis-induced Y-movement of the proof masses 1 into amplified X-movement of the sense shuttles 11.

Each block is suspended above the substrate by means of a multitude set of flexures, subsequently described, which are in turn attached to the substrate by means of fixed anchors 17, also called pedestals. This method of anchoring by means of pedestals rather than directly to the device frame allows the decoupling of the active elements of the device from the environmentally or assembly-induced mechanical stress and strain.

The drive shuttles 2 are primarily coupled to the substrate by means of the primary drive springs 5, to the proof masses 1 by means of the Y-guiding springs 10, and to the outer sync frames 6 and inner sync frames 7 by means of the mechanical amplifier formed by the rigid beams 4. The movement of the drive shuttles 2 is restricted along the X-axis by the guiding flexures 3. The flexures 3 are conveniently implemented as multi-pronged springs tethered to pedestals 17.

The outer sync frames 6 and inner sync frames 7 are connected to each other by a set of structures 9 designed such as the in-phase movement of the frames is suppressed. Furthermore, the movement of the sync frames 6 and 7 is restricted along the Y-axis by the guiding flexures 8. The flexures 8 are conveniently implemented as multi-pronged springs tethered to pedestals 17.

The sense shuttles 11 are primarily coupled to the substrate by means of the primary sense springs 14 and to the proof masses 1 by means of the of the mechanical amplifier beams 13 and the sense mode movable pivots 15. The movement of the sense shuttles 11 is restricted along the X-axis by the guiding flexures 12. The flexures 12 are conveniently implemented as multi-pronged springs tethered to pedestals 17.

The movable pivots 15 are constrained to move only along the Y-axis by the guiding flexures 16. The flexures 16 are conveniently implemented as multi-pronged springs tethered to pedestals 17.

The beams 4, taken all together, form the mechanical amplifier of the drive mode motion. In a similar way, the beams 13, taken all together, form the mechanical amplifier of the Coriolis motion.

FIG. 2 shows schematically the operation of the drive blocks 101, 102, illustrating the amplification of the drive mode motion. When drive forces are applied in opposite Y-directions to the outer 6 and inner 7 sync frames, the beams 4, which are conveniently arranged to form a non-zero angle to the Y-axis, force the shuttles 2 to move along the X-directions. The shuttles 2, through the beams 10, force the proof mass 1 to follow. Owing to the geometry of the system, as it will be shown subsequently, the X-axis displacement 20 of the shuttles 2 is larger than the Y-axis displacement 21 of the sync frames 6, 7.

Furthermore, the frame coupler 9 that couples the sync frames 6 and 7 is designed to suppress the in-phase movement of the said frames. In the preferred embodiment of the frame coupler 9, the movable pivot 18 of the frame coupler 9 is constrained to only move in X-direction by a set of flexures tethered to the pedestals 17. The sync frames 6 and 7, together with the frame couplers 9, ensure the anti-phase movement of the drive blocks 101 and 102.

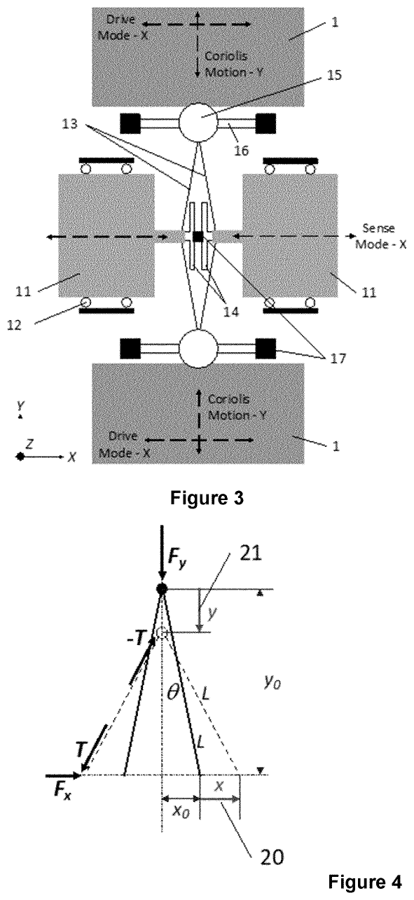

FIG. 3 illustrates schematically the preferred embodiment of the structure that mechanically amplifies the Coriolis movement. The structure comprises:
four rigid beams 13, symmetrically arranged, each forming a non-zero angle to the Y-axis. Each beam 13 is attached to a proof mass 1 and to a sense shuttle 11. The beams of length L are rigid under normal operating conditions, but their joints are flexible, allowing the change of the internal angles when loaded either by the Coriolis force (along Y-axis) or by the sense actuation electrostatic forces (along X-axis);
a pair of primary sense spring systems 14 that restricts the movement of the joints connected to the sense shuttles 11 along the X-axis only; and
two pairs of pivot Y-guiding springs 16 that restricts the movement of the two movable pivots 15 connected to the proof masses 1 along the Y-axis only.

Due to the geometry of the springs and beams and the anchoring method, the in-phase movement of the sense shuttles 11 and of the proof masses 1 are suppressed. In other words, springs may be connected to corresponding anchoring damping structures.

It will be appreciated that, under normal operating conditions, the movable pivots 15 are designed in such a way that they allow the change of the internal angles between the rigid beams 13.

In the presence of angular rates along Z-axis, due to the anti-phase drive motion of the proof masses 1, Coriolis forces will act upon the said proof masses in opposite directions, pushing in opposite directions the movable pivots 15 along the Y-axis. The rigid beams 13, which connect the movable pivots 15 to the sense shuttles 11 while forming a non-zero angle to the Y-axis, combined with the primary sense springs 14, force the shuttles 11 to move along the X-directions. Owing to the geometry of the system, as it will be shown subsequently, the X-axis displacement of the shuttles 11 is larger than the Y-axis displacement of the proof mass 1 and movable pivot 15. Furthermore, the illustrated mechanical amplifier also suppresses the in-phase movement of the sense shuttles 11 along the X-direction and the in-phase moving of the proof masses 1 along the Y-direction.

A key requirement for the proper functionality of the mechanical amplifier is constraining the movable pivots 15 to only move along the Y-axis (along the axis of the Coriolis forces). This may be achieved by using the Y-guiding springs 16 tethered to the pedestals 17. The Y-guiding springs 16 allow bending in the Y-direction but are resilient against forces acting along the X-direction.

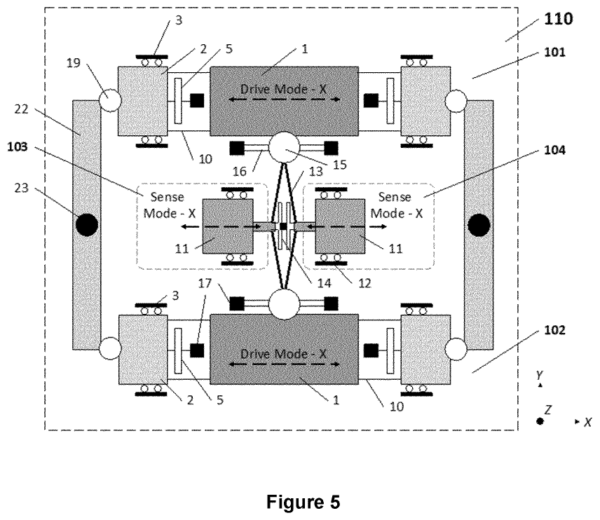

FIG. 4 illustrates a method of calculating the amplification factor of the preferred mechanical amplifier. Assuming that the beams 13 remain rigid (conserving their length L), from the geometry, a small vertical displacement y (21) of the movable pivots 15 corresponds to an amplified displacement x (20) of the sense shuttles 11, where θ is the rest angle between the rigid beams 13 and the Y-direction:

$$x = y \cdot \frac{1}{tan ( θ )}$$

As a typical example, for an angle θ=15°, one gets an amplification factor ζ=x/y=3.73.

Referring to FIG. 4, it will be appreciated that the equilibrium of forces implies:

$${F}_{X} = {F}_{y} \cdot \frac{y}{x} = {F}_{y} \cdot tan ( θ )$$

Preferably, the mechanical amplifiers of the drive mode motion 4, the mechanical amplifier of the Coriolis motion 13 and the frame couplers 9, for simplicity, are designed in a similar way. In dependent aspects of this invention, the three mechanical structures can be designed and optimised independently.

FIG. 5 illustrates the mechanical schematic of the second embodiment of the dual-mass MEMS device for measuring Z-axis angular rate (110), including mechanical amplifiers only for the Coriolis motion (13). The device of FIG. 5 comprises a first pair of identical vibratory structures, the upper drive block 101 and the lower drive block 102, each including a proof mass 1, each proof mass being mechanically coupled to a drive shuttle 2. The drive shuttles 2 generate by electrostatic actuation the drive mode motion of the proof masses 1 in drive mode direction (X). The first pair of vibratory structures 101, 102 are elastically connected by means of synchronizing levers 22, attached to the substrate by means of the fixed pivots 23 that only allow rotations about the Z-axis such that the drive mode corresponds to the anti-phase motion of said proof masses 1, while the in-phase movement of said proof masses 1 and the drive shuttles 2 is suppressed.

The device further comprises a second pair of identical vibratory structures, the left-hand side sense block 103 and the right-hand side sense block 104, each including a sense shuttle 11.

The first and second pairs of vibratory structures are elastically coupled to each other by means of a mechanical structure 13 that converts the Coriolis-induced Y-movement of the proof masses 1 into amplified X-movement of the sense shuttles 11.

The drive shuttles 2 are coupled to the synchronising levers 22 by means of the drive-lever movable pivots 19, which allows the translational movement along the X-axis of the drive shuttles 2 and the rotational movement around the Z-axis of the levers 22.

This embodiment as shown in FIG. 5 does not use a mechanical amplifier for the drive mode motion and, in order to achieve the synchronisation of the drive blocks, levers are employed instead of frames. The result may be a less performant device, but advantageously with smaller size.

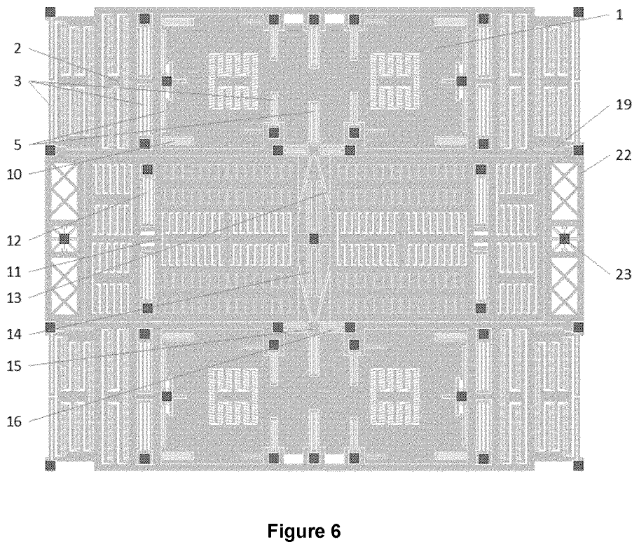

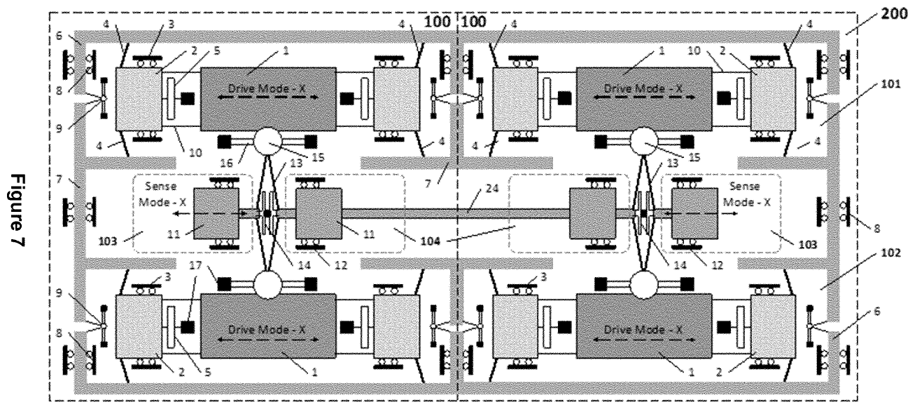

FIG. 6 illustrates a practical implementation of the embodiment of the dual-mass MEMS device 110, shown in FIG. 5.

FIG. 7 illustrates the schematic of a quad-mass MEMS angular rate sensor 200 including mechanical amplifiers for both the drive and the Coriolis motions. The device is realised by mechanically connecting two dual-mass devices 100 with frames (shown in FIG. 1), to achieve, advantageously, better performance, improved stability and improved rejection of vibrations and linear accelerations. The mechanical coupling and synchronisation are realised by the sense connecting beam 24 that connects rigidly the innermost sense shuttles 11.

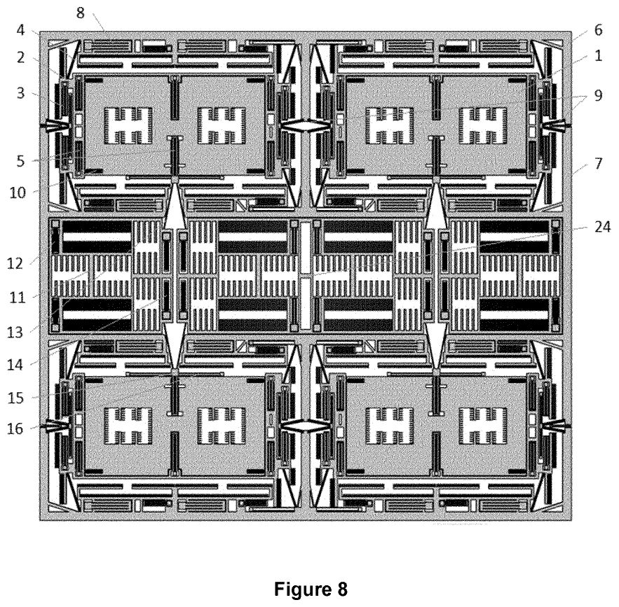

FIG. 8 illustrates a practical implementation of the quad-mass MEMS device 200, shown in FIG. 7.

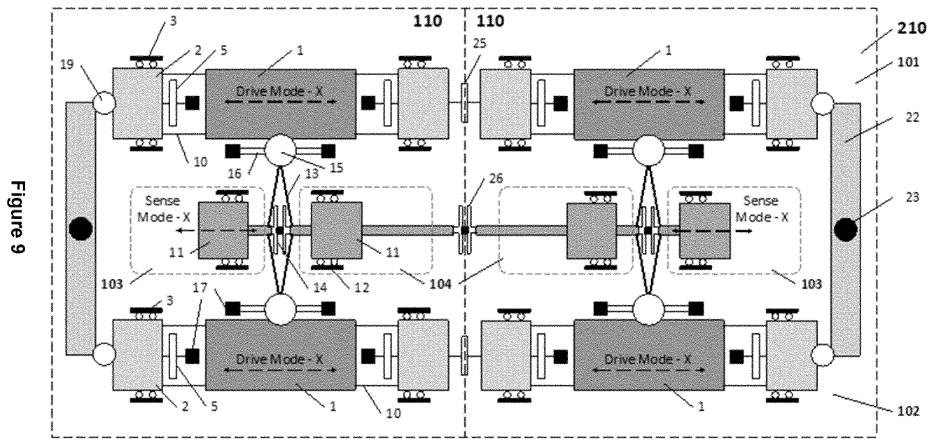

FIG. 9 illustrates the schematic of a quad-mass MEMS angular rate sensor 210 featuring mechanical amplifiers for the Coriolis motion only, the device being realised by mechanically connecting two dual-mass devices 110 with levers (shown in FIG. 5), to achieve, advantageously, better performance, improved stability and improved rejection of vibrations and linear accelerations. The mechanical coupling and synchronisation are realised by the drive connecting springs 25 that connect the innermost drive shuttles 2 and by the sense connecting springs 26 that connect the innermost sense shuttles 11.

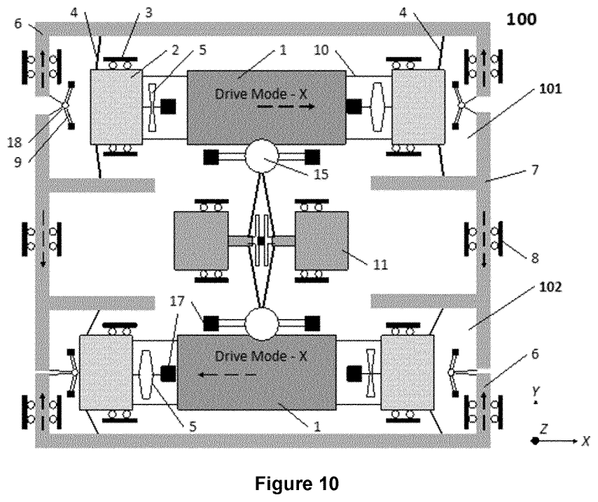

FIG. 10 shows the mechanical schematic of the dual-mass device 100 with frames (shown in FIG. 1) pictured in the drive mode configuration, clearly illustrating the anti-phase movement of the two proof masses 1 and the drive shuttles 2, the deformed primary drive springs 5, the vertically displaced sync frames 6 and 7, and the deformed frame couplers 9.

Advantageously, the Coriolis mechanical amplifier 13 and the sense shuttles 11 remain conveniently unperturbed, i.e. the sense mode is mechanically decoupled from the drive mode.

The frames 6 and 7 allow the synchronisation of the two drive blocks 101 and 102. The guiding flexures 8 constrain the movement of the frames 6 and 7 along the Y-axis.

The movable pivots 15 allow the linear movement along the X-axis of the proof masses 1 without perturbing the Coriolis mechanical amplifier 13.

FIG. 11 shows the mechanical schematic of the dual-mass device 100 with frames (shown in FIG. 1) pictured in the sense mode configuration, clearly illustrating the anti-phase movement of the two proof masses 1 and the sense shuttles 11, the deformed primary sense springs 14, sense pivot Y-guiding springs 16 and proof mass Y-guiding springs 10, and the vertically displaced pivots 15.

The drive shuttles 2 and the sync frames 6 and 7 remain conveniently unperturbed, i.e. the drive mode is mechanically decoupled from the sense mode.

The rigid beams 13 and the primary sense springs 14 allow the synchronisation of the two sense blocks 103 and 104.

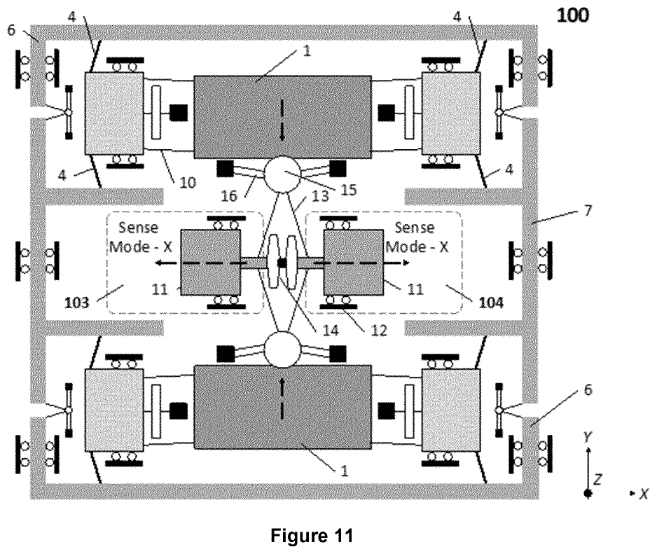

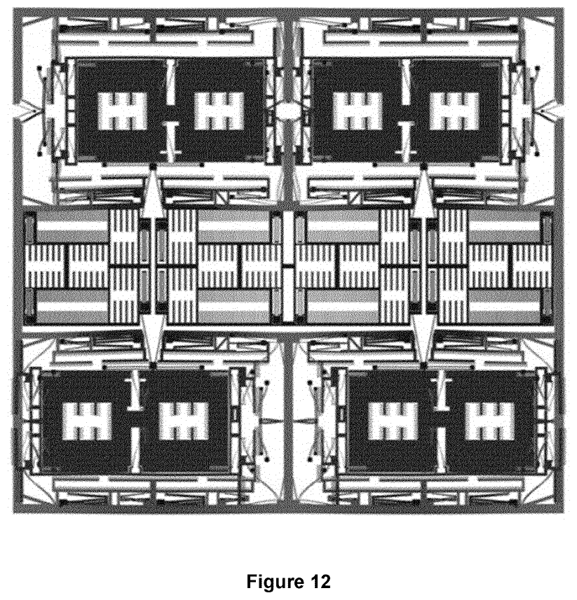

FIG. 12 shows the FEM simulation of the drive motion for the quad-mass device with frames 200, illustrated in FIGS. 7 and 8. For better visualisation of the deformations, the fixed electrodes have been removed and the deformations have been magnified.

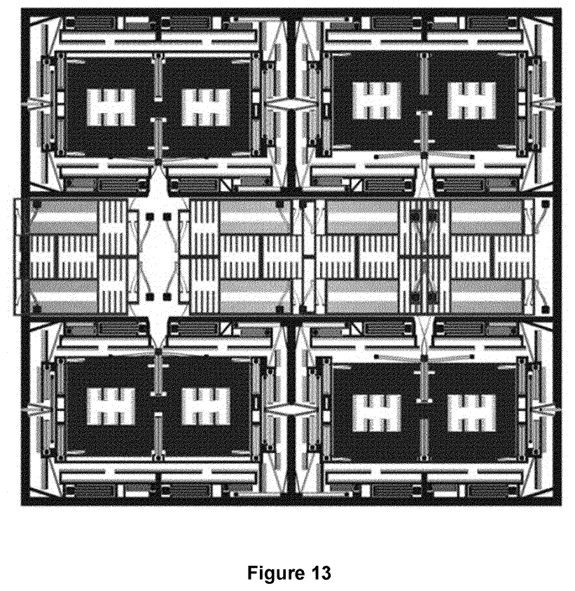

FIG. 13 shows the FEM simulation of the sense motion for the quad-mass device with frames 200, illustrated in FIGS. 7 and 8. For better visualisation of the deformations, the fixed electrodes have been removed and the deformations have been magnified.

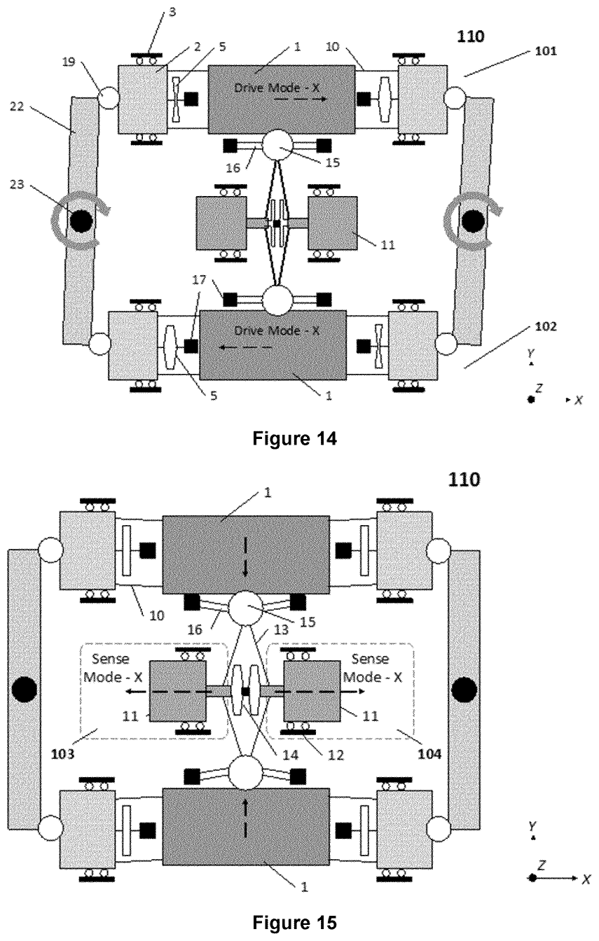

FIG. 14 shows the mechanical schematic of the dual-mass device 110 with levers (shown in FIG. 5) pictured in the drive mode configuration, clearly illustrating the anti-phase movement of the two proof masses 1 and the drive shuttles 2, the deformed primary drive springs 5, and the rotated sync levers 22.

The Coriolis mechanical amplifier 13 and the sense shuttles 11 remain conveniently unperturbed, i.e. the sense mode is mechanically decoupled from the drive mode.

The levers 22 allow the synchronisation of the two drive blocks 101 and 102. The fixed pivots 23 tether the centres of the pivots 22, allowing only rotations about the Z-axis.

The movable pivots 19 allow the rotation of the levers 22 without perturbing the linear movement along the X-axis of the drive shuttles 2.

The movable pivots 15 allow the linear movement along the X-axis of the proof masses 1 without perturbing the Coriolis mechanical amplifier 13.

FIG. 15 shows the mechanical schematic of the dual-mass device 110 with levers (shown in FIG. 5) pictured in the sense mode configuration, clearly illustrating the anti-phase movement of the two proof masses 1 and the sense shuttles 11, the deformed primary sense springs 14, sense pivot Y-guiding springs 16 and proof mass Y-guiding springs 10, and the vertically displaced pivots 15.

The drive shuttles 2 and the sync levers 22 remain conveniently unperturbed, i.e. the drive mode is mechanically decoupled from the sense mode.

The rigid beams 13 and the primary sense springs 14 allow the synchronisation of the two sense blocks 103 and 104.

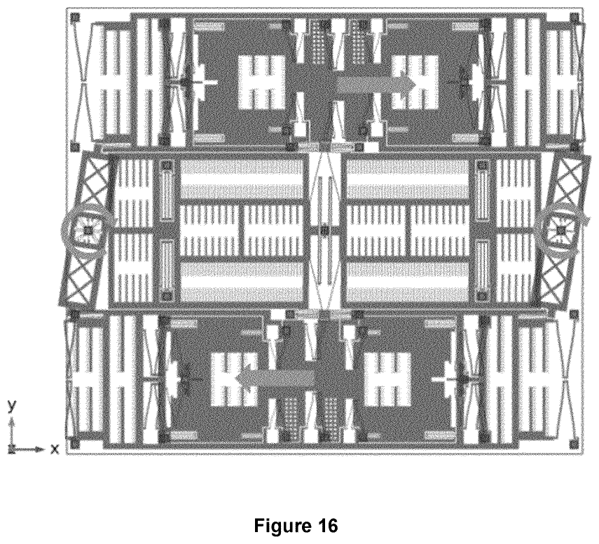

FIG. 16 shows the FEM simulation of the drive motion for the dual-mass device with levers 110, illustrated in FIGS. 5 and 6. For better visualisation of the deformations, the fixed electrodes have been removed and the deformations have been magnified.

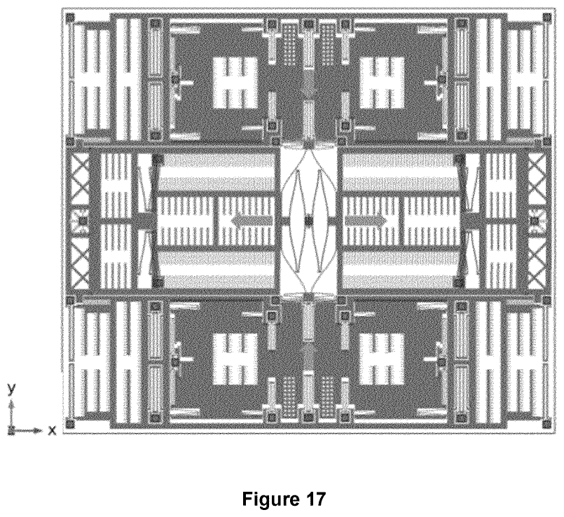

FIG. 17 shows the FEM simulation of the sense motion for the dual-mass device with levers 110, illustrated in FIGS. 5 and 6. For better visualisation of the deformations, the fixed electrodes have been removed and the deformations have been magnified.

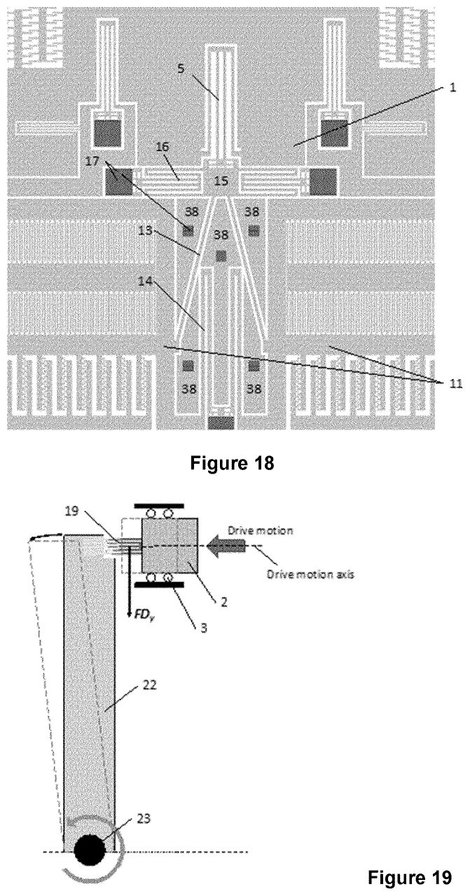

FIG. 18 shows the preferred design of the Coriolis mechanical amplifier 13 according to the present invention. Advantageously, the primary drive springs 5 allow the movement of the proof masses 1 along the X-axis (the drive mode direction), while the movable pivot 15 is constrained by the Y-guiding springs 16 to only move along the Y-axis. In the presence of Coriolis forces, acting along Y-axis, the movable pivots 15 push or pull the rigid beams 13 which at their turn push or pull the sense shuttles 11 along the X-axis, simultaneously loading the primary sense springs 14.

The primary sense springs 14 together with the guiding flexures 12 (see FIG. 6) constrain the two sense shuttles 11 to only move along the X-axis. Advantageously, the springs 12, 14 and 16 are implemented as multi-pronged springs tethered to pedestals 17 to reduce the stress levels and anchor loss, thus considerably increasing the reliability and performance of the device.

For manufacturing purposes, in order to accurately control the dry etching process, filler surfaces 28 were inserted. The filler surfaces 28 are tethered to the substrate by means of pedestals 17.

FIG. 19 shows the schematic of the sync levers 22 according to the alternate embodiments of this invention, the devices with levers 110 and 210. The levers 22 are tethered to the substrate by the means of the fixed pivots 23 that only allow rotations of the said fixed pivots about the Z-axis. In order to decouple the rotational movement of the levers 22 from the linear movement of the drive shuttles 2, the drive-lever pivots 19 have been designed and implemented. These drive-lever pivots 19 considerably reduce the forces FDy exerted by the levers 22 along the Y-axis on the drive shuttles 2, which—in spite of the guiding flexures for the drive shuttles 3, may still result in a quadrature error signal. Note that the implementation illustrated here is based on a similar design by the same author but filed separately.

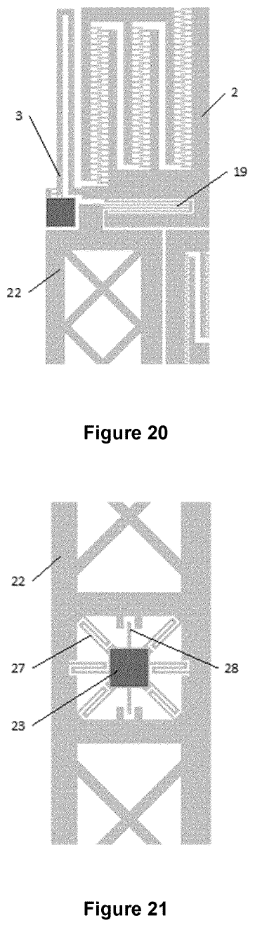

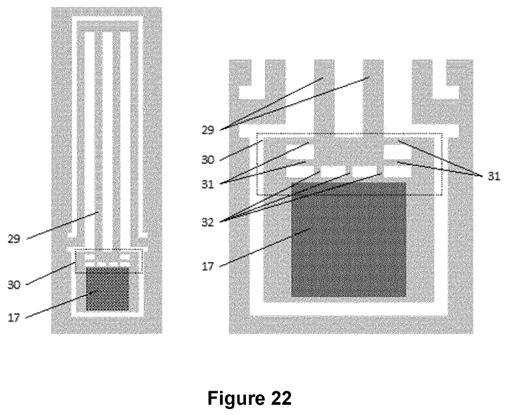

FIG. 20 shows the preferred design of the drive-lever pivots 19 and guiding flexures for the drive shuttles 3 according to the alternate embodiments of this invention, the devices with levers 110 and 210.

FIG. 21 shows the preferred design of the lever fixed pivot 23 according to the alternate embodiments of this invention, the devices with levers 110 and 210. A set of at least 4, but preferably 6, “S”-shaped springs 27, all having one end tethered to the substrate, allow the rotation of the levers 22 about the Z-axis, while all translations are suppressed. Shock absorbers 28, designed as flexible cantilevers with stoppers, are added to limit the rotations of the levers to a maximum value thus protecting the device against large external, mechanical shocks.

Applicable for all of the embodiments described herein, FIG. 13 shows the innovative anchor damping reduction structure 30 according to embodiments of the present invention. Rather than connecting the movable generic springs 29 directly to their corresponding anchors 17, a set of lateral constraining beams 31 are introduced in order to move the clamping/fixed surface of the generic springs 29 away from the anchor 17, thus reducing the energy transported away through the bottom side of the anchor surface. Furthermore, a set of beams 32 is used to reduce the direct attachment area between the generic springs 29 and the anchor 17, thus further reducing the anchor-related losses.

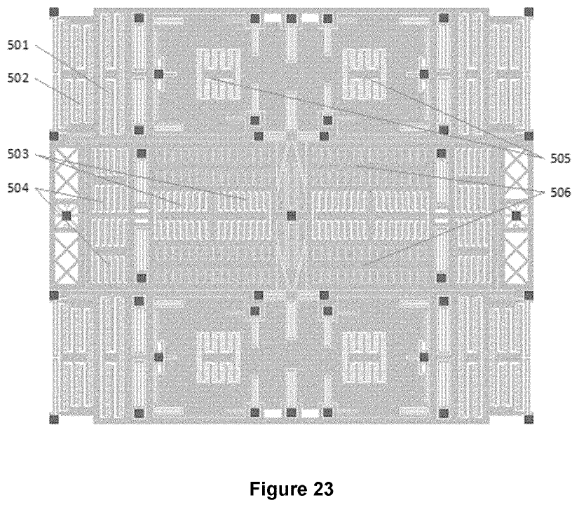

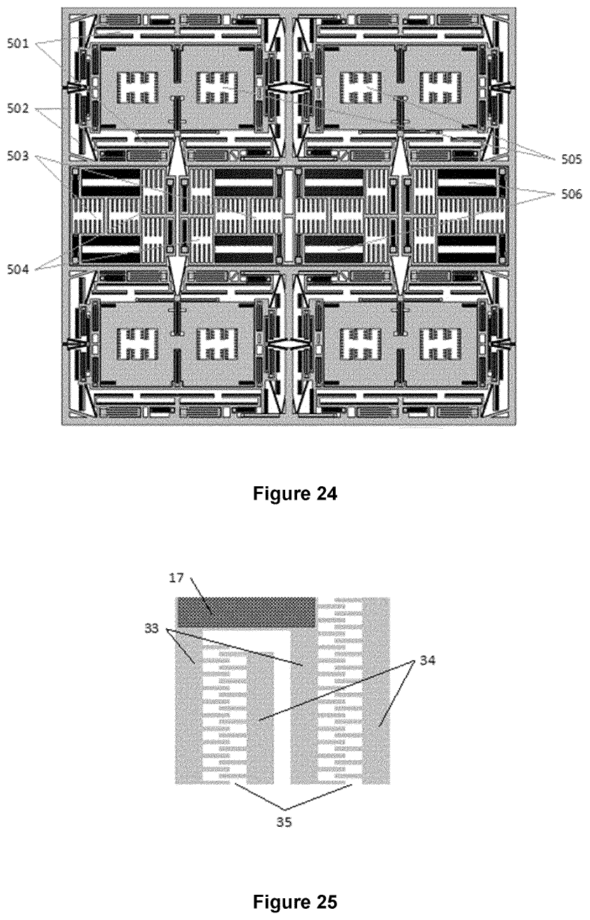

FIGS. 23 and 24 show the location of the various electrical blocks within the dual-mass device with levers 110, respectively the quad-mass device with frames 200.

The drive shuttles 2 contain each a drive actuation block 501 and a drive detection block 502, in which the former is used to electrostatically drive the first pair of vibratory structures (the tines 101 and 102) into an anti-phase oscillation, while the latter is used to measure/quantify the amplitude of the oscillations.

For the quad-mass device with frames 200, the drive actuation blocks 501 are located on the outer sync frame 6, while the drive detection blocks 502 are conveniently located on the drive shuttles 2.

For the dual-mass device with frames 110, the drive actuation blocks 501 and the drive detection blocks 502 are both located on the drive shuttles 2, aligned along the central horizontal axes of the proof masses 1. In an alternate embodiment of the invention, the drive actuation and drive detection blocks can be combined in a single block that will operate in time-multiplexing mode, most of the time as an electrostatic actuator and some of the time as a capacitive amplitude detector.

These particular arrangements, compared to existing prior arts, do not introduce undesired mechanical momenta associated with the drive mode motion.

The sense shuttles 11 contain each a sense actuation block 503 and a sense detection block 504, in which the former is used to electrostatically counteract/balance the movement of the sense vibratory structures 103 and 104, while the latter is used to measure/quantify the amplitude of the residual oscillations. In an alternate embodiment of the invention, the sense actuation and sense detection blocks can be combined in a single block that will operate in time-multiplexing mode, most of the time as an electrostatic actuator and some of the time as a capacitive amplitude detector.

Furthermore, the proof masses 1 contain each a pair of quadrature error compensation blocks 505 which enables the electrostatic compensation of the quadrature errors.

Furthermore, for mode-matched operating devices, the sense shuttles 11 contain each at least on frequency-adjustment block 506 which enables the tuning of the electrostatic damping until the sense mode frequency matches the drive mode frequency.

As already presented and regardless of the actual implementation, the devices employ electrostatic actuation and capacitive detection to generate and detect the motion of the various elements. FIG. 25 shows the preferred embodiment of the comb drives 35 used for the drive and sense mode actuation and detection. They consist of fixed electrodes 33, anchored to the substrate by means of pedestals 17, and movable electrodes 34, attached to the drive and sense shuttles.

As illustrated in FIG. 25, an area closing scheme is preferred, in which, during the movement, the common area between the fingers of the combs is changed. In alternate embodiments of the invention, gap closing schemes, in which the gap between the fingers of the combs is changed, can be employed.

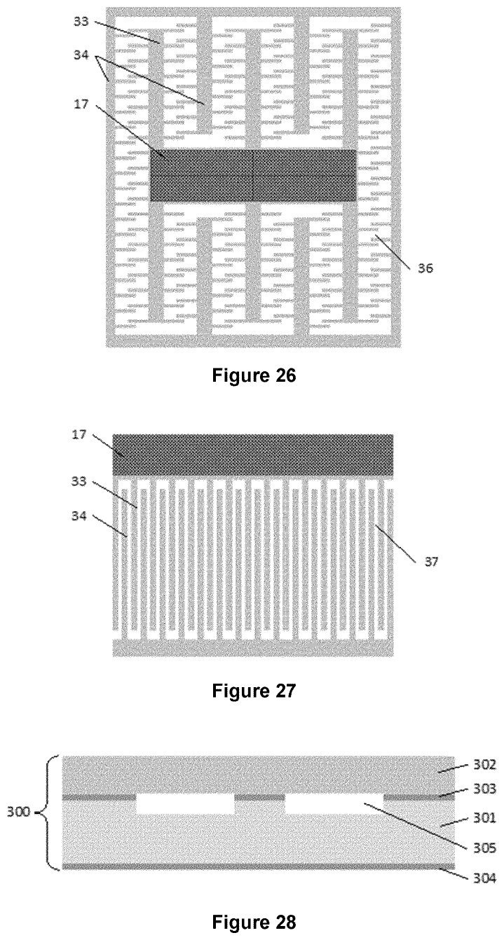

The device may employ electrostatic quadrature compensation blocks 505, illustrated in FIG. 26. The blocks 505 includes a set of comb drives 35 each featuring fixed electrodes 33, anchored to the substrate by means of pedestals 17, and movable electrodes 34, attached to the proof masses 1. Within the designed range of operation, the blocks 505 eliminate the residual quadrature error that may still be present.

The device further employs frequency adjusting blocks 506, illustrated in FIG. 27. The blocks 506 consist of a set of combs 35 each featuring fixed electrodes 33, anchored to the substrate by means of pedestals 17, and movable electrodes 34, attached to the sense shuttles 11. The blocks 506 dampens electrostatically and in a controlled manner the sense mode motion, thus adjusting down its resonance frequency with the purpose of matching the drive mode frequency to achieve the mode-matched operation.

Considering FIG. 28 and regardless of the chosen embodiment, the preferred starting material for fabricating the device is a cavity SOI (C-SOI) wafer 300, consisting of a substrate or handle wafer 301, a device layer 302, an insulating buried oxide (BOX) layer 303, a backside oxide layer 304 needed to control the wafer bow and warp, and the sealed cavities 305 realised in the substrate. The buried oxide layer 303 may be entirely absent from the cavity, as illustrated, or present either on the device layer or the substrate or both.

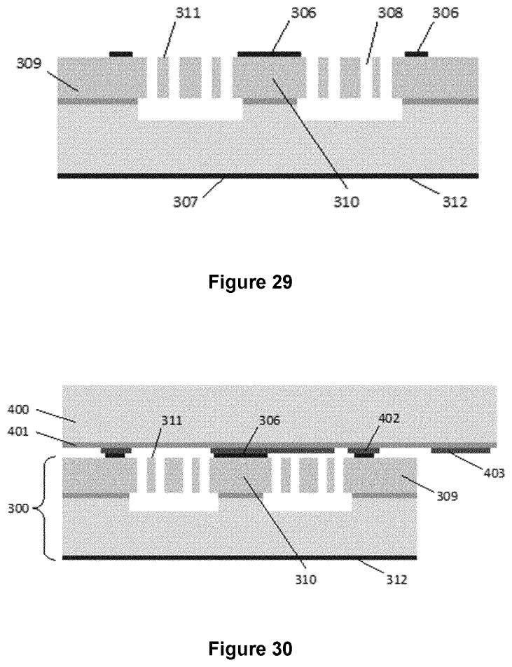

FIG. 29 shows a generic cross-sectional view of the micro-machined C-SOI wafer. A front side metal layer of choice 306 has been deposited and patterned to form one side of the electrical contacts and seal rings. A back side metal layer of choice 307 has been deposited and optionally patterned to form the electrical contact to the substrate. DRIE is used to pattern the device layer in the areas located inside the cavities to define the DRIE trenches 308, the mechanical structures 311 (combs, fingers, springs, proof masse, shuttles, levers etc.), the anchors 310 and the die frame 309.

FIG. 30 shows a generic cross-sectional view of the completely fabricated angular rate device, achieved after wafer-level bonding between the MEMS wafer 300 of FIG. 29 and a capping wafer 400, containing the electrical routing. At least on front side oxide layer 401 is used to provide insulation between the various conductive elements. At least one front side metal layer of choice 402 has been deposited and patterned to form the second side of the electrical contacts and seal rings and insure the necessary routing of signals from the electrodes located on the MEMS wafer 300 to the device pads 403 located on the capping wafer 400.

### REFERENCE NUMERALS DESCRIPTION

100 2-Masses MEMS ARS Structure with Frames
110 2-Masses MEMS ARS Structure with Levers
200 4-Masses MEMS ARS Structure with Frames
210 4-Masses MEMS ARS Structure with Levers
300 C-SOI wafer
400 Capping Si wafer
1 Proof Mass
2 Drive Shuttle
3 Guiding Flexures for Drive Shuttles
4 Drive Amplifier Beam
5 Primary Drive Springs
6 Outer Sync Frame
7 Inner Sync Frame
8 Guiding Flexures for Sync Frames
9 Anti-phase Frame Coupler
10 Proof Mass Y-Guiding Springs
11 Sense Shuttle
12 Guiding Flexures for Sense Shuttles
13 Sense Amplifier Beam
14 Primary Sense Springs
15 Sense Mode Movable Pivot
16 Pivot Y-Guiding Springs
17 Anchors
18 Frame Coupler Pivot
19 Drive-Lever Pivot
20 Amplified Displacement X
21 Source Displacement Y
22 Sync Lever
23 Lever Fixed Pivot
24 Sense Connecting Beam
25 Drive Connecting Springs
26 Sense Connecting Springs
27 Fixed Pivot Springs
28 Fixed Pivot Shock Absorbers
29 Generic Beam
30 Anchor Damping Reduction Structure
31 Lateral Constraining Beams
32 Anchoring Area Reduction Beams
33 Fixed Electrode (Stator)
34 Movable Electrode
35 Drive/Sense Comb Drive
36 Q-Compensation Combs
37 F-Adjust Combs
38 Filler Surfaces
101 Upper drive vibratory structure
102 Lower drive vibratory structure
103 Left sense vibratory structure
104 Right sense vibratory structure
300 C-SOI wafer
301 C-SOI handle wafer (substrate)
302 C-SOI device layer
303 Buried Oxide
304 Backside Oxide
305 Cavity
306 Front Side Metal
307 Back Side Metal
308 DRIE Trenches
309 Die Frame
310 Anchor/Pedestal
311 Mechanical Structures
312 Reference Plane
400 Capping Si wafer
401 Insulating oxides
402 Metal layer 1 and 2
403 Pads
501 Drive Actuation Block
502 Drive Detection Block
503 Sense Actuation Block
504 Sense Detection Block
505 Q-Compensation Block
506 F-Adjustment Block

1. A dual-mass mechanically amplified micro-electromechanical sensor, (MEMS) device for measuring Z-axis angular rate, the sensor comprising:
a substrate which defines a reference plane wherein a Z-axis is substantially perpendicular to the reference plane and an XY plane is defined by the reference plane, the XY plane comprising of an X-axis and a Y-axis which are substantially orthogonal to each other;
a first pair of vibratory structures connected by a rigid frame for structurally providing anti-phase movement of the said vibratory structures at a first predefined frequency at which the in-phase movement of said first pair of vibratory structures is suppressed and said vibratory structures are synchronised, wherein the rigid frame is configured to move perpendicular to a direction of drive mode motion;
a second pair of vibratory structures configured as sense mode mechanism to provide a balanced anti-phase movement to a second predefined frequency, in a direction of sense mode motion, in which the in-phase movement of the second pair of vibratory structures is suppressed;
a pair of mechanical amplifying structures elastically coupling the first pair of vibratory structures to the rigid frame for amplifying the movement of the first pair of vibratory structures, in the direction of drive mode motion, with respect to the movement of the rigid frame; and
a further mechanical amplifying structure elastically coupling the first and the second pairs of vibratory structures to amplify Coriolis-induced movement,
wherein the direction of the sense mode motion is parallel to the direction of drive mode motion.

2. The device of claim 1, wherein said first pair of vibratory structures comprises a first proof mass and a second proof mass, each proof mass being mechanically coupled to a first drive shuttle and to a second drive shuttle, respectively, said drive shuttles for generating drive-mode movements of said proof masses in direction of the drive-mode motion.

3. The device of claim 1, wherein the second pair of vibratory structures comprise a first sense shuttle and a second sense shuttle.

4. The device of claim 2, wherein said drive shuttles are mechanically constrained by a flexure to only move in the direction of the drive-mode motion.

5. The device of claim 3, wherein said sense shuttles are mechanically constrained by a flexure to only move in the direction of the sense-mode motion.

6. The device of claim 1, wherein said further mechanical amplifying structure comprises four rigid beams, symmetrically arranged, each rigid beam forming a non-zero angle to the direction (Y-axis) of the Coriolis-induced motion of said proof masses.

7. The device of claim 6, wherein said rigid beams are connected by elastic joints or pivots to surrounding blocks, for varying the internal angles between said rigid beams, thus amplifying the movement along the X-axis with respect to the movement along the Y-axis.

8. The device of claim 2, wherein the further mechanical amplifying structure comprises a pivot connected to said proof masses and to anchors by a first system of springs.

9. A device of claim 3, wherein the further mechanical amplifying structure comprises a pivot connected to the sense shuttles and to anchors by a second system of springs.

10. The device of claim 1, wherein the said first pair of vibratory structures comprises a first plurality of electrodes for drive movement actuation and a second plurality of electrodes for drive movement amplitude detection.

11. The device of claim 1, wherein the said first pair of vibratory structures comprises a second plurality of electrodes configured to achieve by time multiplexing both the drive movement actuation and the drive movement amplitude detection.

12. The device of claim 1, wherein the said second pair of vibratory structures comprise a first plurality of electrodes for sense movement actuation and a second plurality of electrodes for sense movement amplitude detection.

13. The device of claim 1, wherein the said second pair of vibratory structures comprise a plurality of electrodes configured to achieve by time multiplexing both the sense movement actuation and the sense movement amplitude detection.

14. The device of claim 2, wherein the said proof masses comprise a plurality of electrodes configured to compensate the residual quadrature errors.

15. The device of claim 3, wherein the said sense shuttles comprise a plurality of electrodes configured to electrostatically adjust downwards the sense frequency until matching with the drive frequency is achieved.

16. The device of claim 1, further comprising an anchor damping reduction structure.

17. The device according to claim 16, wherein the anchor damping reduction structure comprises a plurality of lateral constraining beams for blocking the lateral vibration of the springs and for reflecting the acoustic waves associated with the vibratory movement of said springs, and wherein the anchor damping reduction structure further comprises at least one anchor area reduction beams, preferably a plurality of anchor area reduction beams.

18. (canceled)

19. An angular rate MEMS device system comprising two, mechanically coupled; devices according to claim 1.

20. A method of manufacturing the device of claim 1, using a cavity Silicon on-Insulator (CSOI) wafer, the method comprising Deep Reactive Ion Etching (DRIE) processing within a device layer of the CSOI wafer.

21. The method of claim 20, wherein the method further comprises wafer-level-bonding of the said CSOI wafer, wherein a capping silicon wafer comprises electrical routing of signals and device pads.
